(19) United States
(12) Patent Application Publication
(10) Pub. No.: US 2014/0019246 A1
(43) Pub. Date: Jan. 16, 2014

(54) METHOD AND APPARATUS FOR LOCATION BASED CONDITIONAL OFFERS

(71) Applicant: Federico Fraccaroli, Irving, TX (US)

(72) Inventor: Federico Fraccaroli, Irving, TX (US)

(73) Assignee: Federico Fraccaroli, Irving, TX (US)

(21) Appl. No.: 13/548,944

(22) Filed: Jul. 13, 2012

(51) Int. Cl. G06Q 30/02

(52) U.S. Cl. 705/14.58

(57) ABSTRACT

In accordance with an example embodiment of the present invention, a method comprises sending an end user apparatus a conditional business offer and restricting the possibility of acceptance of said conditional business offer via said end user apparatus to at least said end user apparatus being located within a predefined geographical area (acceptance area). In one embodiment of the invention, said conditional business offer is an auction offer.

### BACKGROUND

A geofence is a virtual perimeter for a real-world geographic area. A geofence can be dynamically generated as in a radius around a store or point location. A geofence can also be a predefined set of boundaries connecting points expressed by latitude and longitude, like school attendance zones or neighborhood boundaries. Geofencing has been made possible especially by the introduction of GPS (Global Positioning System) technology and the miniaturization of electronic components that have made the locationing functionality a standard feature in Mobile Phones and portable electronics in general (User Equipment).

In some enactments, geofencing is used for security purposes for example to provide security to wireless local area networks. In some other applications, when a location-aware device in a location-based service (LBS) enters or exits a geofence the device may receive a generated warning. This notice might contain information about the location of the device. The geofence notice might be sent to a mobile telephone or an email account or a web site. Geofencing, when used with child location services, can alert parents when a child leaves a selected area. In other implementations, geofencing allows users of the system to draw zones (geofences) around places of work, customer's sites and secure areas. The crossing of these geofences by an equipped vehicle can trigger a notification to a user or operator via SMS, Email or any other digital indication. The zones can also be linked to equipment within a vehicle and such equipment can stop a vehicle's engine. Geofencing technology can trigger or inhibit functionalities of location aware apparatuses.

According to Contract Law, offer and acceptance analysis is an approach used to define whether an agreement exists between two parties. An agreement may consists of an offer in the form of an indication of one person (the “offeror”) to another (the “offeree”) of the offeror's disposition to enter into a contract on certain terms. A contract is said to come into being when acceptance of an offer (agreement to the terms in it) has been communicated to the offeror by the offeree in accordance with the requirements imposed by the offeror and there has been consideration bargained-for induced by promises or a promise and performance. Conversely, an invitation to treat is not an offer, but a signal of a person's readiness to negotiate a contract. It is a pre-offer statement. The exhibition of goods for sale is typically treated as an invite to treat and not an offer.

Auctions are a particular case. The rule is that the bidder is making an offer to purchase and the auctioneer accepts in any manner that is customary, usually the fall of a hammer. Auctions can be with or without reserve. If an auction is with reserve, the offeree must offer a minimum price for the item or service at auction. If an auction is without reserve, even if there is no contract of sale between the owner of the goods and the highest bidder (because the auction is an invitation to treat or negotiate), there is a collateral contract between the auctioneer and the highest bidder that the auction will be held without reserve (i.e., that the highest bid will be accepted even if low). For example, the U.S. Uniform Commercial Code provides that in an auction without reserve the goods may not be withdrawn once up for bidding.

Microeconomics is a branch of economics that studies the conduct of individuals and how such individuals and firms make decisions on how to allocate limited resources. It applies to markets where goods and services are being bought and sold and examines how these decisions and behaviors control the supply and demand for goods and services, which determines prices, and how prices determine the quantity supplied and quantity demanded of said goods and services.

Goods and services are often perishable; managing inventories of perishable goods is demanding because of their restricted shelf lives. Due to perishability, there is also a price for discarding outdated items; this can lead to out-of-stock situations if the goods are not managed effectively. The outdating of goods is also a relevant aspect. A common remedy for the outdating of goods is to lower the prices of items that are about to be replaced by more modern and functional products to stimulate increase in demand and consequently empty the warehouses. Another motive for lowering the prices of items is a disruption in the technology by means of an innovative product by a competitor that is superior to an existing product. Price promotion is an effective tool where there is demand elasticity.

Differently from goods, services are an intangible commodity; they are the intangible equivalent of economic goods. Services are also perishable in two regards: the relevant resources, processes and systems are assigned for service delivery during a specific period in time. When the service has been completely rendered to the requesting service consumer, this particular service permanently vanishes as the buyer has consumed it. For example, an empty seat on a plane can never be utilized and charged after departure or after a passenger has been transported to destination. In addition, the passenger cannot be transported again to the same location at that point in time. Certain services share a common characteristic with perishable tangible goods: to be consumed or appropriated the physical presence of the offeree (or person who is invited to consume the service) at the location where the service is delivered is often necessary. A few examples of these services are childcare, cleaning, repair, entertainment (when provided live or within a specialized facility), personal grooming, hospitality industry, transport, restaurants.

Herd behavior in marketing is used to explain the dependencies of customers' mutual behavior. The aim is to increase impulse buying and get people to buy more by playing on the herd instinct. The basic idea is that people will buy more of products that are perceived as popular. One example is the tendency of consumer to prefer restaurants, which appear to be relatively busy as compared to restaurants that are almost empty. Various businesses in many different fields try to exploit herd behavior by means of different techniques: coupons, promotional times when items or services are discounted such as ‘happy hours”, introductory rates or events, such as “black Fridays’ where goods are sold at deep discounts to people who often wait in lines at certain locations for a long time.

The present invention draws synergies from the above-mentioned technologies, concepts and observations and provides a method, a system and an apparatus to advantageously evolve and improve the customary methods of conducting commerce.

### SUMMARY

Various aspects of examples of the invention are set out in the claims.

According to a first aspect of the present invention, a method comprises at least providing an end user apparatus a conditional business offer and restricting the possibility of acceptance of said conditional business offer via said end user apparatus to at least said end user apparatus being located within a first predefined geographical area (acceptance area). In one embodiment of the invention, said conditional business offer is an auction offer.

According to a second aspect of the present invention, an apparatus comprises least one processor and one memory containing software code configured to cause the apparatus to perform at least the following: provide a conditional business offer to an end user apparatus and confine the possibility of acceptance of said conditional business offer via said end user apparatus to at least said end user apparatus being located within a first predefined geographical area (acceptance area). In one embodiment of the invention, said conditional business offer is an auction offer.

According to a third aspect of the present invention, a computer software system has a set of instructions for controlling at least one general-purpose digital computer in performing desired functions comprising a set of instructions formed into each of a plurality of modules, each modules comprising a process for providing an end user apparatus a conditional business offer and a process for confining the possibility of acceptance of said conditional business offer via said end user apparatus to at least said end user apparatus being located within a first predefined geographical area (acceptance area). In one embodiment of the invention, said conditional business offer is an auction offer.

### BRIEF DESCRIPTION OF THE DRAWINGS

For a more complete understanding of example embodiments of the present invention, reference is now made to the following descriptions taken in connection with the accompanying drawings in which:

FIG. 1 represents one possible embodiment of the invention in which notification area and acceptance area are separate;

FIG. 2 is a flow diagram showing another possible embodiment wherein acceptance of a conditional business offer a by a mobile user equipment is restricted to said mobile user equipment being located within a predefined acceptance area;

FIG. 3 is a flow diagram showing another possible embodiment wherein the pricing component of a business offer depends on the instantaneous geographical location of User Equipment 160.

FIG. 4 represents a schematic representation of an embodiment of a User Equipment 160.

FIG. 5 represents one possible embodiment of the invention wherein a guided route to acceptance area is provided. In this embodiment, the passing through intermediate waypoints along the guided route (Location Areas) could be an additional requirement of offeror in order to comply with the terms of the offer.

FIG. 6 represents another embodiment of the invention based on concentrically situated areas.

FIG. 7 represents an embodiment of a User Equipment 160 wherein an acceptance module (possibly a graphic on/off button or representation thereof) assumes its acceptance functionality when User Equipment 160 is within an acceptance area.

### DETAILED DESCRIPTION OF THE DRAWINGS

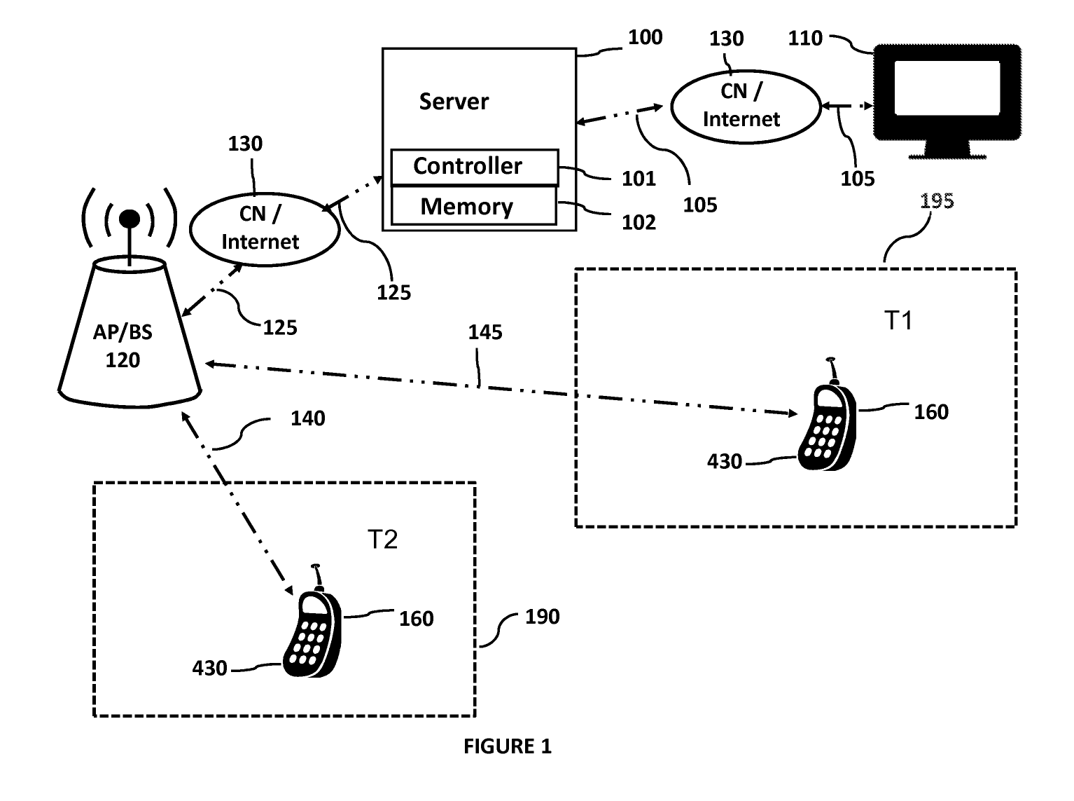

An example embodiment of the present invention and its potential advantages are understood by referring to FIGS. 1 through 7 of the drawings.

FIG. 1 describes a possible embodiment of the invention. User Equipment 160 at time T1 is located in Area 195. Because of its location within Location Area 195 at time T1 and because T1 is comprised in a predefined time window and because User Equipment 160 contains a software application logged on Memory 430, User Equipment 160 may receive a business offer via Radio Link 145 established between User Equipment 160 and Access Point/Base Station (AP/BS) 120 (which for the sake of simplicity in this example is serving both Location Area 195 and Location Area 190). User Equipment 160 could be a mobile phone, a PDA, a laptop, or a tablet or any other wireless mobile device or wearable equipment as long as capable of connecting with Access Point/Base Station (AP/BS) 120. For the purposes of this application, a business offer shall comprise invitations to treat, auction offers or firm offers (namely offers that cannot be withdrawn by the offeror if the offeree complies with the conditions imposed by the offeror) or any other type of business offer. As a non-limiting example, the present invention could be useful to a restaurant. In fact, many restaurants accept reservations that at times are cancelled without a notice. Restricting the possibility of being included in the waiting list only to people located in a surrounding or otherwise defined area may limit the occurrence of false booking.

In the embodiment described in FIG. 1 acceptance of said business offer shall be restricted to Location Area 190, namely User Equipment 160 shall have to move from Location Area 195 to Location Area 190 to enable the user of said User Equipment 160 (the offeree) to accept, treat or negotiate said business offer via a Radio Link 140 (which may or may not be the same as Radio Link 145; an handover to another base station may in fact be necessary to maintain the connectivity with Server 100). Digital information from and to User Equipment 160 shall be communicated via Access Point/Base Station (AP/BS) 120 to Server 100 via Links 125 and Core Network/Internet Cloud 130. Link 125 can be a radio link or any other physical means capable of transporting information, including cable. Server 100 shall include a Controller 101 capable of comparing the information received from User Equipment 160 positioned in Location Area 190 with at least some predefined location parameters and conditions entered by offeror by means of Offeror Equipment 110.

Said location parameters and conditions, stored on Memory 102, via Link 105 and Core Network/Internet Cloud 130 must be satisfied to enable user of User Equipment 160 to accept or negotiate an offer. Offeror Equipment 110 is depicted in FIG. 1 as fixed equipment such as a desktop. The person skilled in the art will recognize that Offeror Equipment 110 is not limited to desktop-type devices but can also be any mobile or wearable device capable of connecting to Server 100 via an Internet connection. In the case of a business offer where the acceptance is restricted to equipment located within a certain location area, said Controller 101 may compare the location information received from said User Equipment 160 with the location conditions imposed by offeror and stored in Memory 102. If the conditions are met, Controller 101 may cause the enabling of the acceptance of the deal. In another implementation, a signal can be sent to User Equipment 160, now positioned in Location Area 190 to unlock an acceptance capability functionality in the user interface, a virtual button on a touch screen, for example.

In one implementation, said virtual button may consist of a representation in a web page opened by a browser connected to an application running on a memory of User Equipment 160. In another implementation, said virtual button may appear directly within said application. The pressing or triggering of such button by offeree will cause User Equipment 160 to send a digital signal to Server 100 causing the acceptance of the offer. In another possible implementation, said comparison between the location conditions imposed by the business offer and the effective location of user equipment may occur by means of computing means at User Equipment 160. In this implementation, said location conditions can be periodically downloaded and stored in Memory 430 of User Equipment 160.

The person skilled in the art will appreciate that conditional business offers need reliable data to ensure that the system described herein works reliably. Location data, among other data, are sensitive and valuable information that neither offeree, offeror nor third parties should be able to manipulate and alter. A trusted security and encryption mechanisms both on the back end side of the system and on the user equipment may be needed to ensure the integrity of the data.

FIG. 1 represents just one of the many possible embodiments of the present invention. In fact, Location Area 195 and Location Area 190 could overlap or be far away from each other so that two different access points or base stations (AP/BS) may be needed to serve User Equipment 160 in the two different areas at times T1 and T2. Moreover, Location Area 195 and Location Area 190 could be defined not only by means of geofencing but also by other different techniques. For example, the range of the radio communication link type employed by Access Point/Base Station (AP/BS) 120 could be a way to define a circular area around an Access Point/Base Station (AP/BS) 120. Furthermore, the radio link could be of many different types such as Wi-Fi, GSM, WCDMA, LTE, CDMA, RF-ID and Bluetooth, just to cite a few non-limiting examples. Location could be provided by many different techniques, for example triangulation with different AP/BS or cell ID or signal strength data from various Access Point/Base Stations 120 coupled with location databases.

In certain settings, where privacy is a concern, the end user's manual input could be needed before his or her location is communicated to Server 100. In the embodiment described and represented in FIG. 1, Location Area 195 is an area of a predefined shape and dimensions; however, in another embodiment of the invention, the area of notification could be indeterminate and the notification of the business offer coming from an offeror could be available to the various offerees generally by means of the traditional generally location-unrestricted Internet. According to one embodiment of the present invention, acceptance (or alternatively the capability to negotiate) of said conditional business offer shall be restricted to a particular location, such as Location Area 190. Sometimes it can be further restricted to a certain time windows.

Restricting customers' acceptance to predefined locations and time windows may serve the purpose of quickly empting perishable inventories since consumers will be drawn in proximity of the inventory. The proximity of the buyer may in fact guarantee that the inventory will be exhausted in a practical time if the goal is to empty the warehouse as soon as possible. It may also create herd consumer behavior. It may also serve the purpose of delivering perishable and localized services, or the advertising and offerings of collateral services and goods. For example, the limiting of the possibility of acceptance of certain business offers to areas, such as Area 190, contained within a pay-to-enter zone such as an amusement park may provide an added incentive to prospective customers of said amusement park to buy an amusement park ticket. The person skilled in the art may realize that this is just one of a multitude of possible examples where an acceptance area can be contained within a pay-to-enter zone. Location Area 190 may also serve the purpose of restricting an auction only to bidders located on the premises. The possibility of bidding may be restricted for many different reasons. For example, only trusted bidders may be allowed to enter Location Area 190.

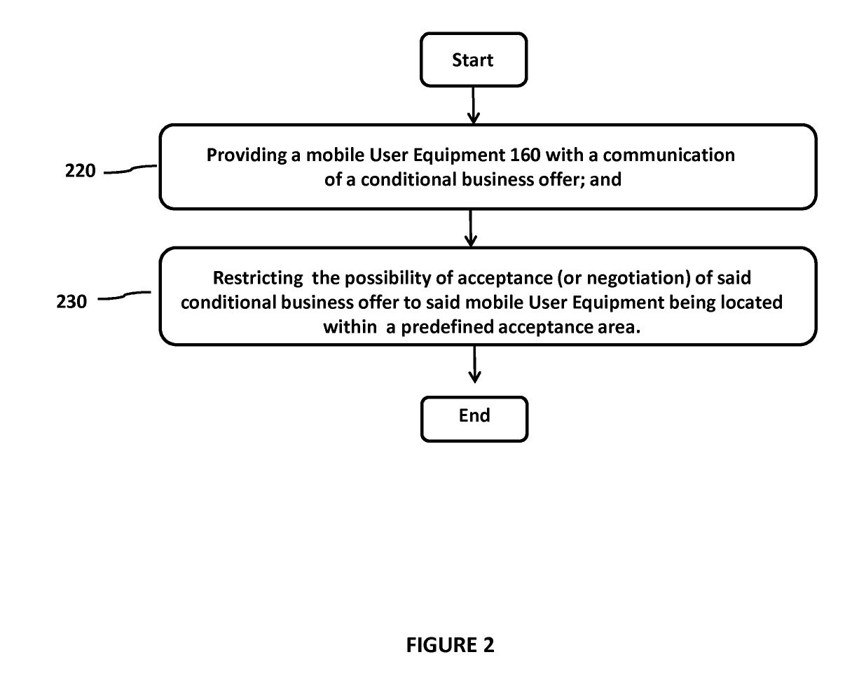

FIG. 2 represents a possible method embodiment of the present invention that can be implemented by means of a computer server such as Server 100. Said method comprises a computer Server 100 1) providing User Equipment 160 with a communication of a conditional business offer (220); and 2) said computer Server 100 restricting the possibility of acceptance (or negotiation) of said conditional business offer to said User Equipment 160 being located within a predefined geographical location (230). In a possible implementation said communication to said User Equipment 165 of said conditional business offer shall also be restricted to User Equipment 165 located within a location area such as Location Area 195. In another possible implementation, said communication shall be further restricted to a particular time window.

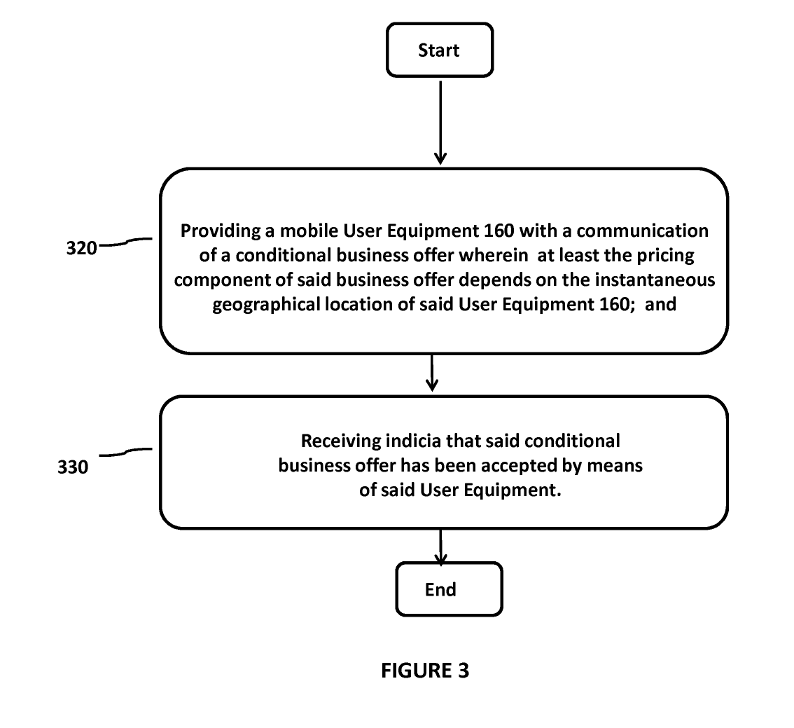

FIG. 3 represents another possible method embodiment of the present invention that can be implemented by means of User Equipment 160 such as a mobile phone, tablet or a portable computer equipment; portable may include ultra-portable or wearable, for example a wristwatch-computer or augmented reality glasses.

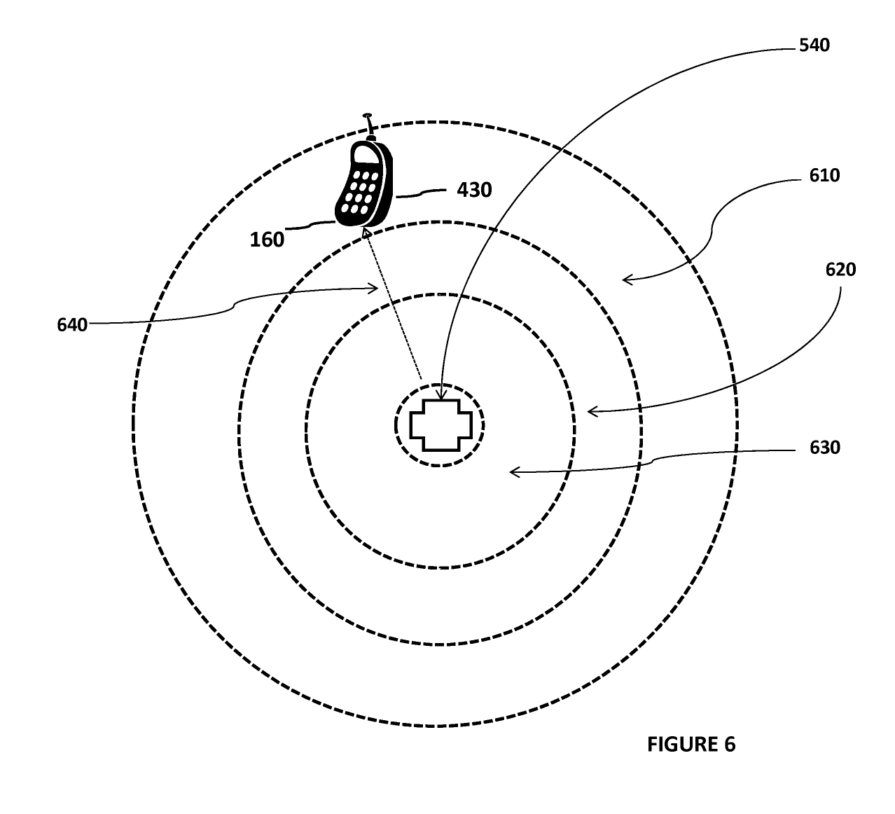

Said method comprises a computer Server 100 or an Offeror Equipment 110: 1) providing a mobile User Equipment 160 with a communication of a conditional business offer wherein the pricing of said business offer depends on the instantaneous geographical location of said User Equipment 160 (320); and 2) receiving indicia that said conditional business offer has been accepted by means of said User Equipment 160. (330). The instantaneous geographical location attribute and its relation to the pricing of the business offer will be further explained with examples in relation to the description of FIG. 6.

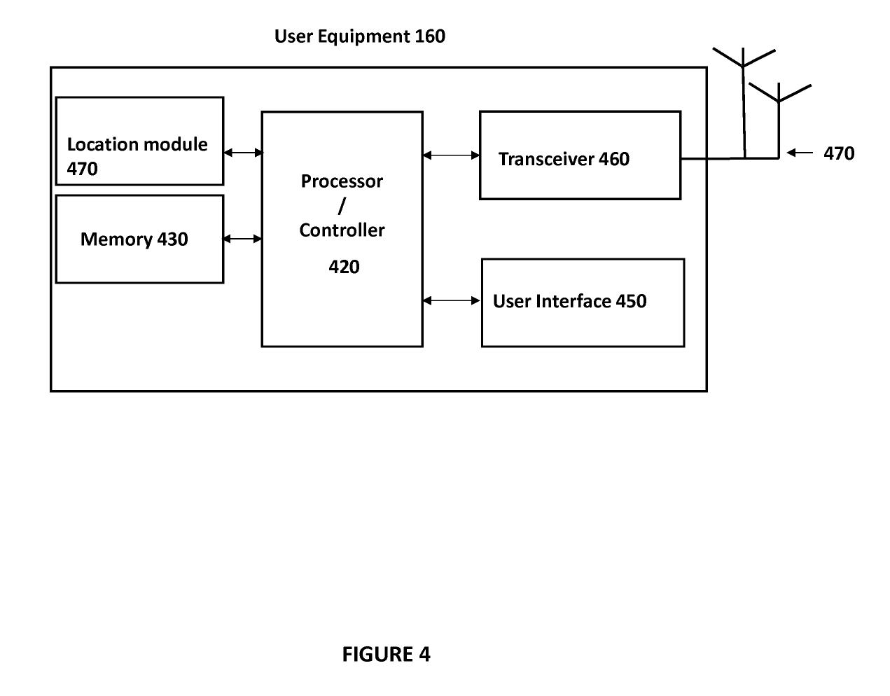

FIG. 4 represents a possible embodiment of User Equipment 160. Said User Equipment 160 shall comprise a Location Module 470 such as, but not limited to, a GPS module, a Memory 430 wherein a software application enabling the reception of conditional business offers has been stored. User Equipment 160 shall also include a Processor/Controller 420 enabling the processing of the information and data necessary for the implementation of the present invention at User Equipment 160. Said Processor/Controller 420 shall interact with a User Interface 450 to enable an end user to input data and preferences and receive information and alerts. Transceiver module 460 coupled with an Antenna 470 shall enable the transferring of data and information from and to User Equipment 160. FIG. 4 representing User Equipment 160 is just one of the many possible embodiments of equipment that can be used to implement the invention. As discussed previously the Location Module 470 may implement a variety of location techniques. For example, RF-ID is a technology that permits short distance communications between a reader and a tag. In a possible embodiment, the radio propagation horizon of the RF-ID tag may serve the purpose of defining said Location areas 190 or 195.

In addition, in some implementations User Equipment 160 described in FIG. 4 may have the same functionalities and structure of Offeror Equipment 110 and be in practice the same. In fact, offeror's equipment and offeree's equipment may be interchangeable if the application running on Memory 430 allows offeror and offeree to log in with their respective logins and passwords and perform the different functions that are related to their roles.

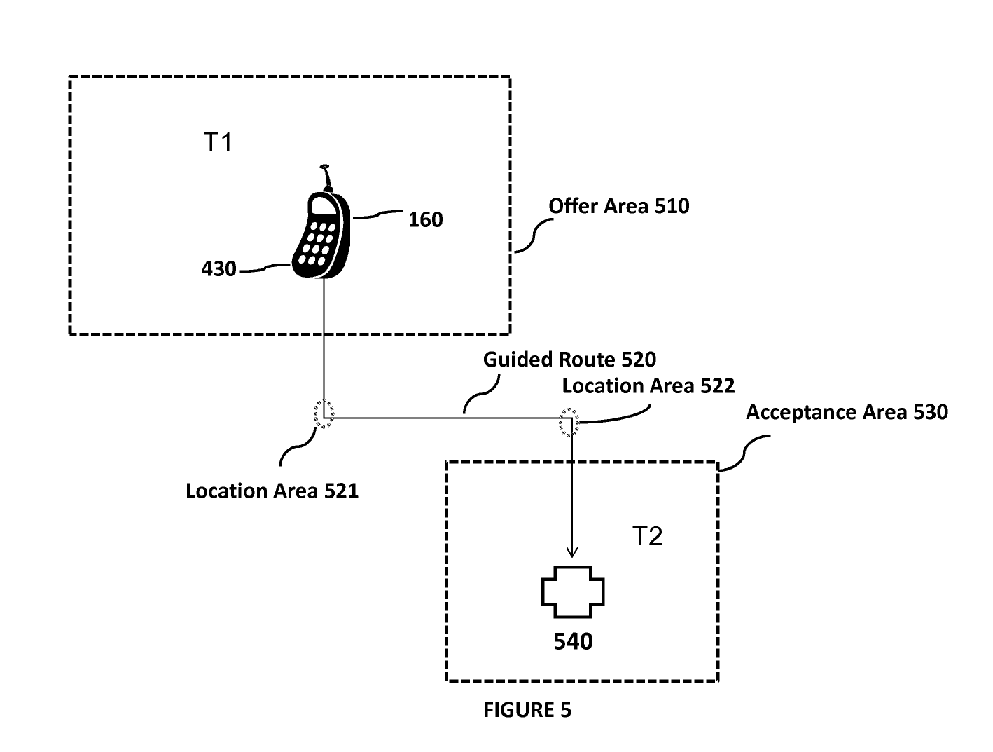

FIG. 5 represents another possible embodiment of the present invention. User Equipment 160 at time T1 is located in Offer Area 510. Because of its location within Offer Area 510 at time T1 and because T1 is comprised within a predefined time window and because User Equipment 160 contains a software application logged on Memory 430, User Equipment 160 may receive a conditional business offer that may be accepted or negotiated only within Acceptance Area 530. Said software application logged on Memory 430 may generate an electronic Guided Route 520 to guide user of User Equipment 160 from his or her position within Offer Area 510 to Acceptance Area 530. Said Acceptance Area 530 may contain an Inventory of Goods or Services 540 that are offered by means of the conditional business offer system that is described in the present application. Said guided route can also be generated by Server 100 and can be sent to User Equipment 160 via an access point or a base station (not depicted). Said Guided Route 520 could be the shortest or fastest route but could also be a route that may serve an ulterior business motive of the offeror such as the display of relevant advertisement, facilities, information and services along the way. In one implementation, not depicted in FIG. 5, Acceptance Area 530 can be defined as a circular area having a set radius and having at its center mobile user equipment wherein said mobile user equipment is controlled by the entity providing the conditional business offer (Offeror Equipment 110 in FIG. 1). In this case, the algorithm set to determine whether the location component of the conditional business offer is satisfied may simply function by determining if the distance between User Equipment 160 and said equipment controlled by the entity providing the conditional business offer is less than said predetermined radius. If so the location component of the conditional business offer is satisfied.

In another possible implementation, the business offer could be restricted not only to the final area of acceptance but also to the observance to the planned route and its intermediate waypoints. For example, user of User Equipment 160 to be able to accept the offer he may have to sequentially pass through intermediate Location Area 521 and Location Area 522. Said areas can coincide with locations that offeror deems advantageous to his or her business. For example, if offeror desires that Inventory of Goods or Services 540 be emptied quickly, Location Area 522 may represent a business location where the offeree may rent a truck for a fee from the offeror or a business partner of the offeror. In addition, conditional offers can be restricted not only to locations but also to other conditional offers that should be accepted in a sequential order to comply with the terms of the offer and unlock additional offers.

In the previous example, the acceptance of a business offer such as the renting of a truck in Location Area 522 can be a prerequisite to unlock the possibility of acceptance of another business offer related to an Inventory of Goods or Services 540 located in Acceptance Area 530. By using the model described, owner of Inventory of Goods or Services 540 can, because of this particular embodiment, bundle one offer to other offers of goods or services. The bundling should be construed in general terms and should not be limited to the selling of tangible goods. Businesses that have synergies with each other or businesses that can offer complementary goods or services at different locations may benefit from this embodiment. For example, the purchase of a tennis racket at Location Area 521 may unlock the possibility of playing tennis for a predefined number of times at certain tennis facilities located, for example, in Acceptance Area 530 at a discounted rate. Temporal restrictions may also require User Equipment 160 to check in at intermediate locations, like Location Area 521 and 522, within a predetermined period to comply with the terms of the offer.

FIG. 6 represents another possible embodiment of the present invention. In this embodiment, Areas 610, 620 and 630 are concentric and non-overlapping areas centered on Inventory of Goods or Services 540. In the present embodiment, Areas 610, 620 and 630 are both offer areas and acceptance areas (formerly separately described in FIG. 5 as Offer area 510 and Acceptance Area 530). In another implementation, the offer areas are undetermined and offers are visible to any equipment capable of connecting to the Internet. User Equipment 160, located in Area 610, may receive a conditional business offer because it contains a software application logged on Memory 430 and is positioned within Area 610. In addition, because of its being positioned within Area 610, User Equipment 160 may be able to accept or negotiate the conditional business offer it has received.

One of the possible purposes of using concentric areas of increasing distance from Inventory of Goods or Services 540 could be to differentiate the conditions or the pricing associated to the conditional offers that users may be able to accept in the different Areas 610, 620 or 630. For example, the pricing of goods or services may decrease with the distance from Inventory of Goods or Services 540 to account for the additional expense associated with the travelling necessary for retrieving or consuming the goods or services in comparison to another user who is located, together with his mobile equipment, in an area that is closer to said Inventory of Goods or Services 540. The person skilled in the art may be aware that this is only one possible example of many. Different business models may call for an opposite or different pricing scheme. For example, the price for a service or a commodity may increase with the increasing distance of the zone where a service or a good has to be delivered from the location of Inventory of Goods or Services 540.

FIG. 6 represents discrete areas; Area 610, Area 620 and Area 630 are areas of possible acceptance. However, in a potential implementation said areas can collapse into discrete circumferences of radius Distance 640. In this implementation, the Distance 640 from Inventory of Goods and Services 540 may dictate the pricing of the location-based offer. In FIG. 6, said distance is shown as a geometrical distance calculated using a straight line, namely Distance 640. In other implementations, said distance can be a distance calculated by using geographical and topological data retrieved from an electronic map. An algorithm running on Server 100 may employ different kinds of routing and parameters (including a turn by turn routing) to derive a pricing figure. For example, the fastest route, (considering the traffic conditions or the various speed limits for each street or highway), or the shortest route may be employed to create the conditions and pricing attached to the offer.

The embodiment just described is one example of location-constrained offer and location-constrained acceptance system that is subject to many variations. In fact, if the system is a fine-grained system the offeree will be able to observe via his User Equipment 160 the pricing and the conditions of the conditional offer he receives may fluctuate and continuously and instantaneously adjust to variations in the location of said User Equipment 160. If the system is a coarse-grained system, such adjustments will be more infrequent. In another embodiment, the zones of acceptance and/or offering may not be positioned concentrically and distance from Inventory of Goods and Services 540 may not play a major role in defining the pricing and conditions of the offer. Offeror may in fact opt for zoning an area, such as a city or a county, using geofencing technology and differentiate among different zones based on various criteria such as income, age, marital status, gender or other such economic considerations as the presence of business partners who can fulfill orders and demand. Pricing, offerings and the possibility of acceptance can be tailored to the characteristics and demographics of the particular geofenced zone where User Equipment 160 is located at a certain moment in time. In a possible implementation, algorithms creating continuously varying clouds of offer and acceptance zones may dictate the pricing. In this case, zones of offer and acceptance may coincide and collapse into small and granular areas distributed across larger areas.

A technical effect of one or more of the example embodiments disclosed herein is that business models based on offers and acceptances that are restricted to selected location areas will encourage applications and security mechanisms to ensure that the position a User Equipment 160 is reporting to Server 100 is accurate so that Controller 101 can process verified, accurate and trusted data.

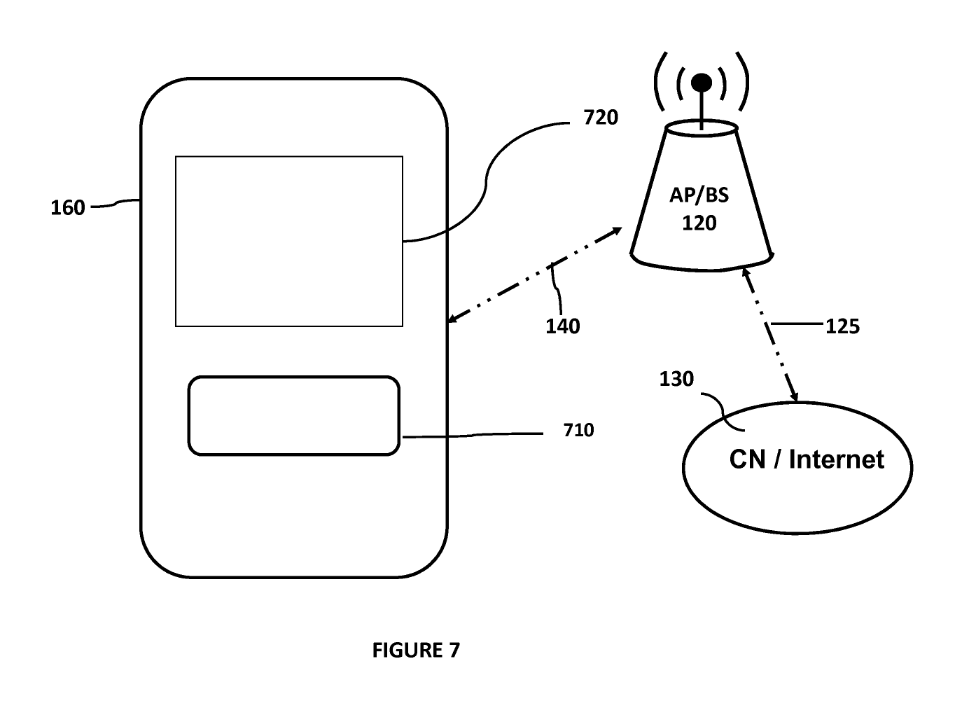

FIG. 7 represents a schematic illustration of a User Equipment 160. Said User Equipment 160 may exchange data with Access Point/Base Station 120 and connect to the Core Network/Internet Cloud 130 via Link 140 and Link 125. Module 720 represents an output mechanism indicating to a user the details and the conditions attached to the location-based conditional offer. Said Module 720 may also indicate to user turn-by-turn directions to an Acceptance Area 530 either via a graphical representation or via audio directions. Module 710 may represent a button that may transit from an inactive state to an active state when User Equipment 160 moves into an acceptance zone and vice-versa. Said button icon could be either be the product of a representation provided by an application running on Memory 430 or could be the product of a representation provided by an Internet browser application.

Auctions (with or without reserve) are a special case. Acceptances may only be provisional and subject to the outbidding of other offerees during the auction time interval. In a possible implementation, Module 710 is active in Acceptance Area 530 and its triggering may signal to Server 100 a bidding acceptance during the auction. Said bidding acceptance could be the acceptance of the price at which offeror (real person or computer process running the auction) is currently offering the item for sale during the ongoing auction and at which the item will actually be sold if no higher acceptance is received within the auction time interval (and the reserve price has been met). In one implementation, every time a user accepts an auction offer price the system may automatically increase the offer price by a set amount and send another auction offer notification to every user within the Offer Area 510 and Acceptance Area 530. In this case, offer area and acceptance area may partially overlap or perfectly coincide. A bidding acceptance via User Equipment 160 may only be tentative and subject to the outbidding of other users located within the same Acceptance Area 530 during the auction time interval related to the item or service being offered. In another implementation user of User Equipment 160 may be able to submit his price independently from the current auction offer price via User Interface 450 of User equipment 160. Module 720 may indicate to user of User Equipment 160 the existing highest accepted bid. It may also indicate the time left for submitting a new bid. Once a predetermined time allocated to the bidding process has elapsed, Module 720 may alert the highest bidder of his or her win.

The person skilled in the art may recognize that the kind of mobile apparatus represented in FIG. 7 is a traditional handheld apparatus. Said apparatus class may one day be replaced by wearable equipment or augmented reality equipment. Module 710 and Module 720 may in fact exist as a mere visual representation and displayed in front of a user's eye if said user is using augmented reality equipment. The acceptance or any other input may occur by gestures of the hands of a user (or other) that an input module of said augmented reality equipment may capture and translate into a command. Such virtual input/output modules can one day replace the traditional Module 710 and Module 720 while delivering essentially the same functionalities.

Embodiments of the present invention may be implemented in software, hardware, application logic or a combination of software, hardware and application logic. The software, application logic and/or hardware may reside on mobile computer equipment, fixed equipment or servers that may not even be owned or operated by an offeror as, for example, in the case of cloud computing. If desired, part of the software, application logic and/or hardware may reside on multiple servers and equipment in charge of different processes (for example authentication, payment and conditional business offer input), part or all of the software, application logic and/or hardware may reside on equipment owned by the same business owner who may be providing the conditional business offer (offeror), and part of the software, application logic and/or hardware may reside on mobile equipment that is owned by offerees.

In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of computers described and depicted in FIG. 1 (100, 110 and 160). A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined. As technology advances, new equipment and techniques can be viable substitutes of the equipment and techniques that have been described in this application.

Although various aspects of the invention are set out in the independent claims, other aspects of the invention comprise other combinations of features from the described embodiments and/or the dependent claims with the features of the independent claims, and not solely the combinations explicitly set out in the claims. The above described example embodiments of the invention should not be viewed as limiting but merely as explanatory. Rather, there are several variations and modifications, which may be made without departing from the scope of the present invention as, defined in the appended claims.

What is claimed is:

1-40. (canceled)

41. A machine implemented method for facilitating the transacting of a location restricted business offer comprising:
at least partially causing the sending of said location restricted business offer to a user apparatus wherein the possibility of acceptance of said location restricted business offer is regulated by at least the condition that said user apparatus be located within a first geographical area wherein said first geographical area is at least partially defined by data stored on a non-transitory computer-readable medium.

42. The method of claim 41 wherein said partially causing the sending of said location restricted business offer to said user apparatus is regulated by at least the condition that said user apparatus be located within a second geographical area wherein said second geographical area is at least partially defined by data stored on a non-transitory computer-readable medium.

43. The method of claim 42 wherein said second geographical area contains said first predefined geographical area.

44. The method of claim 41 wherein at least a price component of said location restricted business offer is dependant from the instantaneous location of said user apparatus.

45. The method of claim 41, wherein said location restricted business offer is an auction-type offer.

46. The method of claim 41 further comprising:
at least partially causing said user apparatus to provide indications apt to guide a user to said first geographical area.

47. Apparatus comprising:
at least one processor; and
at least one memory including computer program code, the at least one memory and the computer program code configured to, with the at least one processor, cause the apparatus to perform at least the following:
at least partially causing the sending of said location restricted business offer to a user apparatus wherein the possibility of acceptance of said location restricted business offer is restricted by at least the condition that said user apparatus be located within a first geographical area wherein said first geographical area is at least partially defined by data stored on a non-transitory computer-readable medium.

48. The apparatus of claim 47, wherein said partially causing the sending of said location restricted business offer to said user apparatus is associated to at least the condition that said user apparatus be located within a second geographical area wherein said second geographical area is at least partially defined by data stored on a non-transitory computer-readable medium.

49. The apparatus of claim 48, wherein said second geographical area contains said first geographical area.

50. The apparatus of claim 47 wherein at least a price component of said location restricted business offer is dependant from the instantaneous location of said user apparatus.

51. The apparatus of claim 47 comprising:
at least one processor; and
at least one memory including computer program code, the at least one memory and the computer program code configured to, with the at least one processor, cause the apparatus to additionally perform at least the following:
at least partially causing said user apparatus to provide directions to said first geographical area.

52. An apparatus comprising:
means for displaying a location restricted business offer; and
means for facilitating the acceptance of said location restricted business offer wherein said means for facilitating said acceptance are at least partially affected by the condition that said apparatus be located within a first geographical area.

53. The apparatus of claim 52 wherein said displaying of said location restricted business offer is at least partially associated to said apparatus being located within a second geographical area.

54. The apparatus of claim 52 further comprising:
means for providing directions to said first geographical area.

55. A computer software system having a set of instructions for controlling at least one general-purpose digital computer in performing desired functions comprising:
a set of instructions formed into each of a plurality of modules and stored in at least one non-transitory computer-readable medium, each modules comprising:
a process for at least partially causing the sending of a location restricted business offer to a user apparatus wherein the possibility of acceptance of said location restricted business offer is associated to at least the condition that said user apparatus be located within a first geographical area wherein said first geographical area is at least partially defined by data stored on a non-transitory computer-readable medium.

56. The computer software system of claim 55 further comprising:
a process for regulating said at least partially causing the sending of a location restricted business offer to said user apparatus via the condition that said user apparatus be located within a second geographical area wherein said second geographical area is at least partially defined by data stored on a non-transitory computer-readable medium.

57. The computer software system of claim 56 wherein said second geographical area contains said first geographical area.

58. The computer software system of claim 55 further comprising:
a process for communicating a price component of said location restricted business offer to said user apparatus wherein said price component is at least partially dependant from the location of said user apparatus.

59. The computer software system of claim 55 further comprising:
a process for at least partially causing said user apparatus to provide directions to said first predefined geographical area.

60. The computer software system of claim 55 wherein said location restricted business offer is an auction-type offer.
